(19) United States
(12) Patent Application Publication
(10) Pub. No.: US 2008/0070618 A1
(43) Pub. Date: Mar. 20, 2008

(54) Cellular communications device, method and circuit

(76) Inventor: Mikael Hjelm, Vaestera (SE)

Correspondence Address: INFINEON TECHNOLOGIES AG;Patent Department, MUC 11.1.507, P.O. Box 221644, Munich, 80506, omitted

(21) Appl. No.: 11/521,650

(22) Filed: Sep. 15, 2006

(51) Int. Cl. H04Q 7/20; H04M 1/00

(52) U.S. Cl. 455/552.1; 455/426.2; 455/462

(57) ABSTRACT

A cellular-communications device comprises a cellular-communications transceiver to communicate via a cellular-communications system; a local-communications transceiver to communicate via a local-communications system; and a switch coupled to said local-communications transceiver to switch it on when a probability value indicates, that said cellular-communications device is within a communications range of a base station of said local-communications system. A communications method comprises providing communication via a cellular-communications system; and switching on communication via a local-communications system when within a communications range of a base station of said local-communications system based a probability value.

### FIELD OF THE INVENTION

Embodiments of the invention described herein relate generally to cellular-communications devices and more particularly to mobile phones.

### BACKGROUND OF THE INVENTION

Conventional mobile phones utilize a cellular-communications system, that is a network. However, some of these conventional mobile phones also utilize a local-communications system, that is network. Thus, they may either operate simultaneously in the cellular network and the local network, or require user interaction for selecting the cellular network and the local network. The former approach leads to an increased power consumption, the latter approach is cumbersome and reduces flexibility.

However, as physical dimensions of mobile phones grow smaller and keys grow smaller, power consumption and usability of mobiles phones play an important role.

For these and other reasons, there is a need for the invention as set forth in the following in the embodiments.

### BRIEF DESCRIPTION OF THE SEVERAL VIEWS OF THE DRAWING(S)

While the specification concludes with claims particularly pointing out and distinctly claiming that which is regarded as the invention, a more particular description of the invention will be rendered by reference to specific embodiments thereof, which are depicted in the appended drawings, in order to illustrate the manner in which embodiments of the invention are obtained. Understanding that these drawings depict only typical embodiments of the invention, that are not necessarily drawn to scale, and, therefore, are not to be considered limiting of its scope, embodiments will be described and explained with additional specificity and detail through use of the accompanying drawings in which:

FIG. 1. shows a cellular-communications device according to an embodiment of the invention;

FIG. 2. shows a local-communications system according to an embodiment of the invention;

FIG. 3. shows a state diagram of a cellular-communications device according to another embodiment of the invention; and

FIG. 4. shows a local-communications system according to another embodiment of the invention.

### DETAILED DESCRIPTION OF THE INVENTION

In the following detailed description of the embodiments, reference is made to the accompanying drawings which form a part hereof and show, by way of illustration, specific embodiments in which the invention may be practiced. In the drawings, like numerals describe substantially similar components throughout the several views. The embodiments are intended to describe aspects of the invention in sufficient detail to enable those of skill in the art to practice the invention. Other embodiments may be utilized and structural, logical or electrical changes or combinations thereof may be made without departing from the scope of the invention. Moreover, it is to be understood, that the various embodiments of the invention, although different, are not necessarily mutually exclusive. For example, a particular feature, structure or characteristic described in one embodiment may be included within other embodiments. Furthermore, it is to be understood, that embodiments of the invention may be implemented in discrete circuits, partially integrated circuits or fully integrated circuits or programming means. Also, the term “exemplary” is merely meant as an example, rather than the best or optimal. The following detailed description is, therefore, not to be taken in a limiting sense, and the scope of the invention is defined only by the appended claims, along with the full scope of equivalents to which such claims are entitled.

Reference will be made to the drawings. In order to show the structures of the embodiments most clearly, the drawings included herein are diagrammatic representations of inventive articles. Thus, actual appearance of the fabricated structures may appear different while still incorporating essential structures of embodiments. Moreover, the drawings show only the structures necessary to understand the embodiments. Additional structures known in the art have not been included to maintain clarity of the drawings. It is also to be understood, that features and/or elements depicted herein are illustrated with particular dimensions relative to one another for purposes of simplicity and ease of understanding, and that actual dimensions may differ substantially from that illustrated herein.

In the following description and claims, the terms “include”, “have”, “with” or other variants thereof may be used. It is to be understood, that such terms are intended to be inclusive in a manner similar to the term “comprise”.

In the following description and claims, the terms “coupled” and “connected”, along with derivatives such as “communicatively coupled” may be used. It is to be understood, that these terms are not intended as synonyms for each other. Rather, in particular embodiments, “connected” may be used to indicate, that two or more elements are in direct physical or electrical contact with each other. However, “coupled” may also mean that two or more elements are not in direct contact with each other, but yet still co-operate or interact with each other.

In the following description and claims, terms, such as “upper”, “lower”, “first”, “second”, etc., may be only used for descriptive purposes and are not to be construed as limiting. The embodiments of a device or article described herein can be manufactured, used, or shipped in a number of positions and orientations.

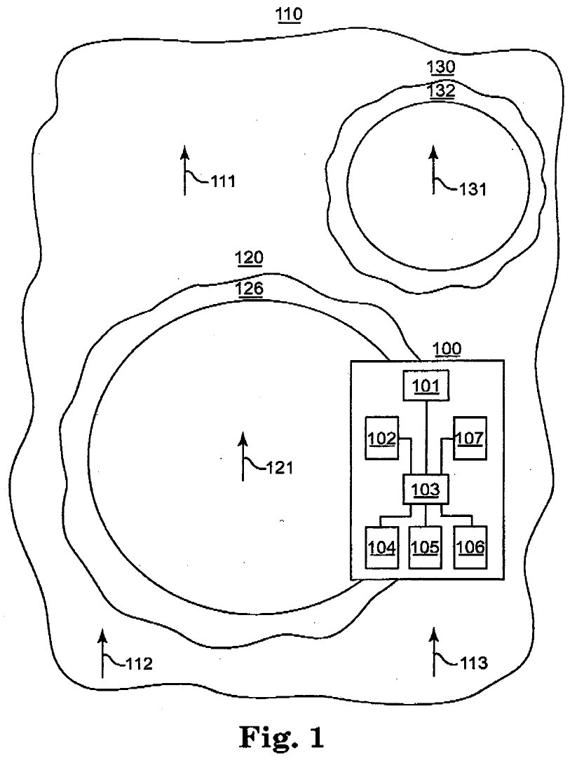

FIG. 1. shows a cellular-communications device 100 according to an embodiment of the invention. The cellular-communications device 100 comprises a cellular-communications transceiver 101 to communicate via a cellular-communications system 110 having base stations 111, 112 and 113, a first local-communications transceiver 102 to communicate via a first local-communications system 120, and a switch 103 coupled to said first local-communications transceiver 102 to switch it on when a first probability value indicates, that said cellular-communications device 100 is within a first communications range 122 of a first base station 121 of said first local-communications system 120.

Features of the cellular-communications device 100 are increased flexibility, reduced electromagnetic radiation, reduced power consumption, and reduced costs including air-time costs.

The first probability value may be based on time, such as time of day. Thus, the cellular-communications device 100 may further comprise a timer 104 coupled to said switch 103 to provide time information.

The first probability value may be based on a location of the cellular-communications device 100. Thus, the cellular-communications device 100 may further comprise a locator 105 coupled to switch 103 to determine the location of said cellular-communications device 100.

The locator 105 may be adapted to operate with a satellite navigation system, such as global positioning system (GPS), assisted GPS (A-GPS), or Galileo. The locator 105 may be adapted to operate with triangulation, and said triangulation may be based on cellular base stations or broadcasting stations, such TV stations.

The locator 105 may also be adapted to operate with identifications of cellular base stations, to track said location of said cellular-communications device 100 from a previous location of said cellular-communications device 100 or to determine said location of said cellular-communications device 100 from an Earth magnetic field.

The cellular-communications device 100 may further comprise a memory 106 coupled to said switch 103 to store first location information of said first base station 121. Said first location information may comprise position information of said first base station 121, and information on said first communications range 122 of said first base station 121. The cellular-communications device 100 may be adapted to store said first location information in said memory 106 based on user interaction or signal information of said first base station 121, such as signal strength or signal quality.

The switch 103 may be coupled to said cellular-communications transceiver 101 to switch it off when said first local-communications transceiver 102 is switched on.

The first local-communications transceiver may be adapted to operate according to a cordless telephone standard, a Digital Enhanced Cordless Telecommunications (DECT) standard, a wireless local area network (WLAN) standard, a Bluetooth standard, a ultra-wide band (UWB) standard or the like.

The cellular-communications device 100 may further comprise a second local-communications transceiver 107 to communicate via a second local-communications system 130, and switch 103 may be coupled to said second local-communications transceiver 107 to switch it on when a second probability value indicates, that said cellular-communications device 100 is within a second communications range 132 of a second base station 131 of said second local-communications system 130.

Switch 103 may be coupled to said cellular-communications transceiver 101 to switch it off when said second local-communications transceiver 107 is switched on. Furthermore; said switch 103 may be coupled to said first local-communications transceiver 102 to switch it off when said second local-communications transceiver 107 is switched on.

Second local-communications transceiver 107 may be adapted to operate according to a cordless telephone standard, a DECT standard, a WLAN standard, a Bluetooth standard, a ultra-wide band (UWB) standard or the like.

Cellular-communications transceiver 101 may be adapted to operate according to a Global System for Mobile Communications (GSM) standard, a Universal Mobile Telecommunications System (UMTS) standard or the like.

According to another embodiment of the invention, a mobile phone 100 comprises a cellular-communications transceiver 101 to communicate via a cellular-communications system 110, a local-communications transceiver 102 to communicate via a local-communications system 120, and a switch 103 coupled to said local-communications transceiver 102 to switch it on when location information of said cellular-mobile phone 100 and location information of a base station 121 of said local-communications system 120 indicate, that said mobile phone 100 is within a communications range 122 of said base station 121.

According to yet another embodiment of the invention, a circuit comprises a cellular-communications circuit to communicate via a cellular-communications system, a local-communications circuit to communicate via a local-communications system, and a switch coupled to said local-communications circuit to switch it on when location information of said communications circuit and location information of a base station of said local-communications system indicate, that said communications circuit is within a communications range of said base station.

The communications circuit may be situated on an integrated circuit.

A communications method according to a further embodiment of the invention comprises providing communication via a cellular-communications system, and switching on communication via a local-communications system when within a communications range of a base station of said local-communications system based a probability value.

The probability value may be based on time. Thus, the communications method may further comprise providing time information.

The probability value may also be based on a location of said communications method. Thus, the communications method may further comprise determining said location of said communications method.

The determining may comprise using a satellite navigation system, such as GPS, A-GPS, or Galileo. Said determining may also comprise using triangulation, and said triangulation may be based on cellular base stations or broadcasting stations, such as TV stations.

The determining may also comprise using identifications of cellular base stations, tracking said location of said communications method from a previous location of said communications method, or determining said location of said communications method from an Earth magnetic field.

The communications method may further comprise storing location information of said base station. Said location information comprises position information of said base station, and information on said communications range of said base station. Said storing may comprise storing said location information based on user interaction, or storing said location information based on signal information of said base station.

The communications method may further comprise switching off communication via said cellular-communications when communications via said local-communications is switched on.

Local-communications may be according to a cordless standard, a DECT standard a WLAN standard, a Bluetooth standard, a ultra-wide band (UWB) standard or the like.

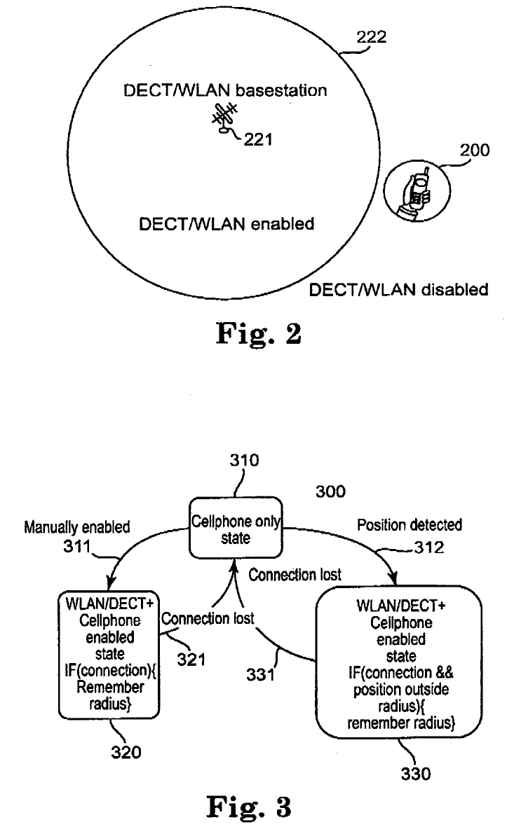

FIG. 2. shows a local-communications system according to an embodiment of the invention. The local-communications system comprises a base station 221, and may operate according to a DECT, WLAN, Bluetooth or UWB standard. Within a communications range 222 DECT/WLAN communication of a mobile phone 200 is enabled. Outside the communications range 222 DECT/WLAN communication is disabled. As communications via a cellular network (not shown) may always be enabled, a position of the mobile phone 200 may be extracted as discussed with reference to FIG. 1. The mobile phone 200 determines, using position information relating to the mobile phone 200 and the base station 221, whether the DECT/WLAN communication should be enabled.

FIG. 3. shows a state diagram 300 of a cellular-communications device according to another embodiment of the invention. The state diagram 300 shows enabling and disabling of the local, that is DECT/WLAN, communication of a mobile phone. Normally, the mobile phone is in a cell phone-only state 300. When the mobile phone detects, that its position is within communications range of a local, that is DECT/WLAN, base station (312), the mobile phone switches into a cell phone+DECT/WLAN-enabled state 330. If the mobile phone is within the communications range of the base station, but its position is outside a previously stored communications range of the base station, the mobile phone may store a new communications range for future use. If the mobile then looses the connection to the base station (331), the mobile phone returns to the cell phone-only state 310. When a user of the mobile phone manually enables the DECT/WLAN communication (311), the mobile phone switches to a DECT/WLAN-enabled state 320. The user may position the mobile phone close to the base station. As the mobile phone is then removed from the base station, the mobile phone determines the communications range of the base station and stores the communications range for future use. When the connection is lost (321), the mobile phone returns to the cell phone-only state 310.

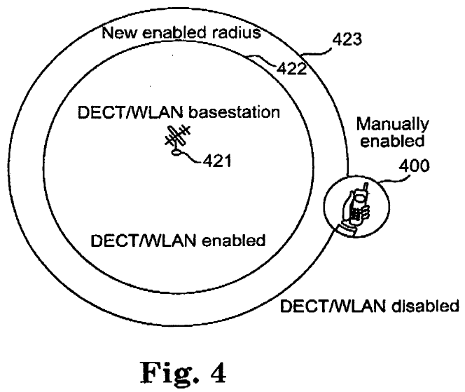

FIG. 4. shows a local-communications system according to another embodiment of the invention. FIG. 4 corresponds with FIG. 2. However, if a user manually enables the local, that is DECT/WLAN, communications range, the mobile phone stores information regarding a new communications range 423 as discussed with reference to FIG. 3.

As the mobile phone may utilize a plurality of communications networks, it is possible to minimize costs of operation. However, the mobile phone may need appropriate rights to access and use a particular communications network.

Although specific embodiments have been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any other embodiments and applications in which the above structures and methods may be used. The scope of the invention should, therefore, be determined with reference to the appended claims along with the full scope of equivalents to which such claims are entitled.

It is emphasized that the Abstract is provided to comply with 37 C.F.R. section 1.72(b) requiring an abstract that will allow the reader to quickly ascertain the nature and gist of the technical disclosure. It is submitted with the understanding, that it will not be used to interpret or limit the scope or meaning of the claims.

What is claimed is:

1. A cellular-communications device, comprising:
a cellular-communications transceiver to communicate via a cellular-communications system;
a first local-communications transceiver to communicate via a first local-communications system; and
a switch coupled to said first local-communications transceiver to switch it on when a first probability value indicates that said cellular-communications device is within a first communications range of a first base station of said first local-communications system.

2. The cellular-communications device of claim 1, wherein:
said first probability value is based on time.

3. The cellular-communications device of claim 2, further comprising:
a timer coupled to said switch to provide time information.

4. The cellular-communications device of claim 1, wherein:
said first probability value is based on a location of said cellular-communications device.

5. The cellular-communications device of claim 4, further comprising:
a locator coupled to said switch to determine said location of said cellular-communications device.

6. The cellular-communications device of claim 5, wherein:
said locator is adapted to operate with a satellite navigation system.

7. The cellular-communications device of claim 6, wherein:
said satellite navigation system is one of GPS, A-GPS, and Galileo.

8. The cellular-communications device of claim 5, wherein:
said locator is adapted to operate with triangulation.

9. The cellular-communications device of claim 8, wherein:
said triangulation is based on one of cellular base stations and broadcasting stations.

10. The cellular-communications device of claim 9, wherein:
said broadcasting stations are TV stations.

11. The cellular-communications device of claim 5, wherein:
said locator is adapted to operate with identifications of cellular base stations.

12. The cellular-communications device of claim 5, wherein:
said locator is adapted to track said location of said cellular-communications device from a previous location of said cellular-communications device.

13. The cellular-communications device of claim 5, wherein:
said locator is adapted to determine said location of said cellular-communications device from an Earth magnetic field.

14. The cellular-communications device of claim 5, further comprising:
a memory coupled to said switch to store first location information of said first base station.

15. The cellular-communications device of claim 14, wherein:
said first location information comprises:
position information of said first base station, and
information on said first communications range of said first base station.

16. The cellular-communications device of claim 14, wherein:
said device is adapted to store said first location information in said memory based on one user interaction and signal information of said first base station.

17. The cellular-communications device of claim 1, wherein:
said switch is coupled to said cellular-communications transceiver to switch it off when said first local-communications transceiver is switched on.

18. The cellular-communications device of claim 1, wherein:
said first local-communications transceiver is adapted to operate according to one of a DECT standard, a WLAN standard, a Bluetooth standard and a UWB standard.

19. The cellular-communications device of claim 1, further comprising:
a second local-communications transceiver to communicate via a second local-communications system; and
wherein:
said switch is coupled to said second local-communications transceiver to switch it on when a second probability value indicates, that said cellular-communications device is within a second communications range of a second base station of said second local-communications system.

20. The cellular-communications device of claim 19, wherein:
said switch is coupled to said first local-communications transceiver to switch it off when said second local-communications transceiver is switched on.

21. The cellular-communications device of claim 20, wherein:
said second local-communications transceiver is adapted to operate according to one of a DECT standard, a WLAN standard, a Bluetooth standard, a UWB standard, a GSM standard, and a UMTS standard.

22. A mobile phone, comprising:
a cellular-communications transceiver to communicate via a cellular-communications system;
a local-communications transceiver to communicate via a local-communications system; and
a switch coupled to said local-communications transceiver to switch it on when location information of said cellular-mobile phone and location information of a base station of said local-communications system indicate, that said mobile phone is within a communications range of said base station.

23. A circuit, comprising:
a cellular-communications circuit to communicate via a cellular-communications system;
a local-communications circuit to communicate via a local-communications system; and
a switch coupled to said local-communications circuit to switch it on when location information of said communications circuit and location information of a base station of said local-communications system indicate, that said communications circuit is within a communications range of said base station.

24. The circuit of claim 23, wherein:
said communications circuit is situated on an integrated circuit.

25. A communications method, comprising:
providing communication via a cellular-communications system; and
switching on communication via a local-communications system when within a communications range of a base station of said local-communications system based a probability value.

26. The communications method of claim 25, wherein:
said probability value is based on time.

27. The communications method of claim 26, further comprising:
providing time information.

28. The communications method of claim 25, wherein:
said probability value is based on a location of said communications method.

29. The communications method of claim 28, further comprising:
determining said location of said communications method.

30. The communications method of claim 29, wherein:
said determining comprises:
using a satellite navigation system.

31. The communications method of claim 30, wherein:
said satellite navigation system is one of GPS, A-GPS, and Galileo.

32. The communications method of claim 29, wherein:
said determining comprises:
using triangulation.

33. The communications method of claim 32, wherein:
said triangulation is based on one of cellular base stations and broadcasting stations.

34. The communications method of claim 33, wherein:
said broadcasting stations are TV stations.

35. The communications method of claim 29, wherein:
said determining comprises:
using identifications of cellular base stations.

36. The communications method of claim 29, wherein:
said determining comprises:
tracking said location of said communications method from a previous location of said communications method.

37. The communications method of claim 29, wherein:
said determining comprises:
determining said location of said communications method from an Earth magnetic field.

38. The communications method of claim 29, further comprising:
storing location information of said base station.

39. The communications method of claim 38, wherein:
said location information comprises:
position information of said base station, and
information on said communications range of said base station.

40. The communications method of claim 38, wherein:
said storing comprises:
storing said location information based on user interaction.

41. The communications method of claim 38, wherein:
said storing comprises:
storing said location information based on signal information of said base station.

42. The communications method of claim 25, further comprising:
switching off communication via said cellular-communications when communications via said local-communications is switched on.

43. The communications method of claim 25, wherein:
said local-communications is according to a DECT standard, a WLAN standard, a Bluetooth standard, and a UWB standard.
